(19) United States
(12) Patent Application Publication
(10) Pub. No.: US 2010/0323868 A1
(43) Pub. Date: Dec. 23, 2010

(54) BAG-MAKING AND PACKAGING APPARATUS

(75) Inventors: Hideshi Miyamoto, Ritto (JP); Shinji Koike, Ritto (JP)

Correspondence Address: GLOBAL IP COUNSELORS, LLP, 1233 20TH STREET, NW, SUITE 700, WASHINGTON, DC, 20036-2680, US

(73) Assignee: ISHIDA CO., LTD., Kyoto (JP)

(21) Appl. No.: 12/486,997

(22) Filed: Jun. 18, 2009

(51) Int. Cl. B31B 1/26

(52) U.S. Cl. 493/243

(57) ABSTRACT

A bag-making and packaging apparatus includes a bag-making and packaging mechanism and a fold formation mechanism. The fold formation mechanism is configured and arranged to deform a packaging material from a planar state to a folded state having a cross-sectional shape including a fold portion formed by three creases, and to feed the packaging material to the bag-making and packaging mechanism. The fold formation mechanism may include a conveying path regulating part that defines a part of a conveying path of the packaging material with the conveying path regulating part temporarily bending the packaging material for a plurality of times. The bag-making and packaging apparatus may further includes a slanting member for slanting the fold portion to be generally parallel to a region of the packaging material other than the folding section, and a conveying angle changing member disposed downstream of the slanting member.

### BACKGROUND OF THE INVENTION

1. Field of the Invention

The present invention relates to a bag-making and packaging apparatus, and particularly relates to a bag-making and packaging apparatus for manufacturing a bag having a fold portion.

2. Background Information

In the past, bag-making and packaging apparatuses have been used in which sheet-shaped packaging materials are used so as to fill the insides of bags with snack foods or other packaged goods while the bags are being manufactured. Self-standing bags are examples of bags manufactured by a bag-making and packaging apparatus, including standing pouches such as the one shown in FIGS. 1A and 1B, and gusset bags such as the one shown in FIG. 11. Self-standing bags are excellent for their ease of exhibiting products and their display effects, and the demand for such bags has recently been increasing.

A gusset bag has hems or ribs at the four corners of a rectangular tubular film. The hems are formed by partially folding the packaging material (for example, see International Publication No. WO01/24999). At the top of a standing pouch such as the one shown in FIGS. 1A and 1B, a large fold portion is formed for attaching a zipper for enabling the pouch to be resealed after being opened.

In view of the above, it will be apparent to those skilled in the art from this disclosure that there exists a need for an improved bag-making and packaging apparatus. This invention addresses this need in the art as well as other needs, which will become apparent to those skilled in the art from this disclosure.

### SUMMARY OF THE INVENTION

The large fold portion of a standing pouch as described above and the hems of a gusset bag may be formed by the same method. However, the fold portion to be formed in a standing pouch has a larger portion of overlapping packaging material in comparison with the hems formed in a gusset bag. Therefore, when the packaging material is partially folded by the same method as the method for manufacturing a gusset bag as described above, excessive wrinkles are formed in the manufactured bag, which is undesirable.

Accordingly, one object of the present invention is to provide a bag-making and packaging apparatus for reducing the wrinkles formed in bags having a fold when the bags are manufactured.

A bag-making and packaging apparatus according to a first aspect includes a bag-making and packaging mechanism and a fold formation mechanism. The bag-making and packaging mechanism is configured and arranged to manufacture a bag in which articles are packaged. The fold formation mechanism is configured and arranged to deform a packaging material from a planar state to a folded state having a cross-sectional shape including a fold portion formed by three creases, and to feed the packaging material to the bag-making and packaging mechanism. The fold formation mechanism has a conveying path regulating part that defines a part of a conveying path of the packaging material with the conveying path regulating part being configured and arranged to temporarily bend the packaging material for a plurality of times.

A bag-making and packaging apparatus includes a bag-making and packaging mechanism, a fold formation mechanism, a slanting member and a conveying angle changing member. The bag-making and packaging mechanism is configured and arranged to manufacture a bag in which articles are packaged. The fold formation mechanism is configured and arranged to deform a packaging material from a planar state to a folded state having a cross-sectional shape including a fold portion formed by three creases, and to feed the packaging material to the bag-making and packaging mechanism. The slanting member is configured and arranged to slant the fold portion to be generally parallel to a region of the packaging material other than the folding section. The conveying angle changing member is disposed downstream of the slanting member with respect to a conveying direction of the packing material, and configured and arranged to change a conveying angle of the packing material. The conveying angle changing member is disposed in a position displaced from an imaginary plane toward a side where the fold portion is formed, the imaginary plane being obtained by extending a conveyance surface of the region other than the fold portion in the fold formation mechanism toward the conveying direction of the packing material.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1A is a perspective view of an example of a standing pouch manufactured by a bag-making and packaging apparatus according to an embodiment of the present invention;

FIG. 1B is a side view of the standing pouch illustrated in FIG. 1A;

FIG. 2 is an external perspective view of the bag-making and packaging apparatus;

FIG. 3 is a schematic side view showing a conveyed path of a film in the bag-making and packaging apparatus;

FIG. 4 is a schematic side view of a fold formation unit of the bag-making and packaging apparatus;

FIG. 5A is a schematic perspective view showing a conveying path regulating part of the bag-making and packaging apparatus;

FIG. 5B is a schematic perspective view showing a film passing through the conveying path regulating part of the bag-making and packaging apparatus;

FIG. 5C is an enlarged view of a portion of the fold formation unit of the bag-making and packaging apparatus;

FIG. 5D is a drawing showing the arrangement of a channel member and cover member of the conveying path regulating part;

FIG. 6 is a enlarged partial view of a fold formation part;

FIG. 7 is a partial cross sectional view of the fold formation part showing the positional relationship of the members as seen along a dashed line 7-7 in FIG. 4;

FIG. 8 is a enlarged partial side view of a film guide;

FIG. 9A is a schematic drawing showing the positional relationship of the fold portion with respect to the main portion of the film as seen from the dashed line 9A-9A in FIG. 4;

FIG. 9B is a schematic drawing showing the positional relationship of the fold portion with respect to the main portion of the film and a slanting member as seen from the dashed line 9B-9B in FIG. 4;

FIG. 9C is a schematic drawing showing the positional relationship of the fold portion with respect to the main portion of the film and a slanting member as seen from the dashed line 9C-9C in FIG. 4;

FIG. 9D is a schematic drawing showing the positional relationship of the fold portion with respect to the main portion of the film and a slanting member as seen from the dashed line 9D-9D in FIG. 4;

FIG. 10 is a schematic side view of a bag-making and packaging unit; and

FIG. 11 is a drawing showing a gusset bag.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

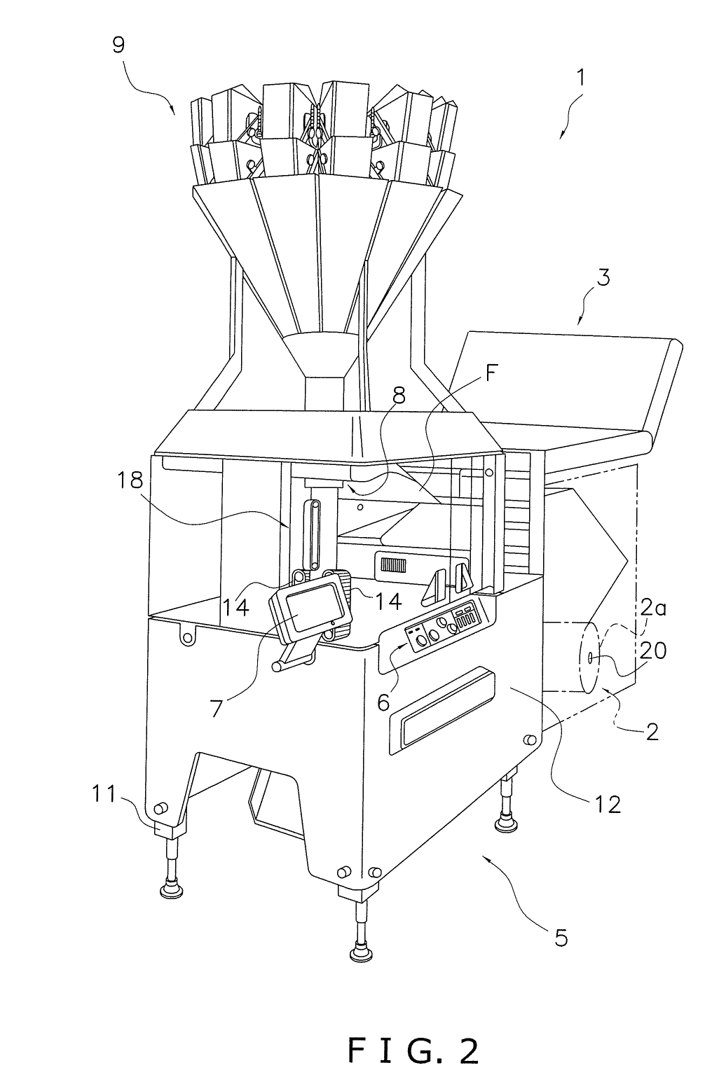

A bag-making and packaging apparatus 1 is illustrated in accordance with an embodiment of the present invention. In the following description, the front side of the bag-making and packaging apparatus 1 refers to a side on which a liquid crystal display 7 of the bag-making and packaging apparatus 1 is attached as shown in FIG. 2. The terms “left” and “right” pertaining to the bag-making and packaging apparatus 1 refer to a case of viewing the bag-making and packaging apparatus 1 from the front, and the terms “upstream” and “downstream” pertaining to the bag-making and packaging apparatus 1 refers to upstream and downstream in relation to the conveying direction of the film F.

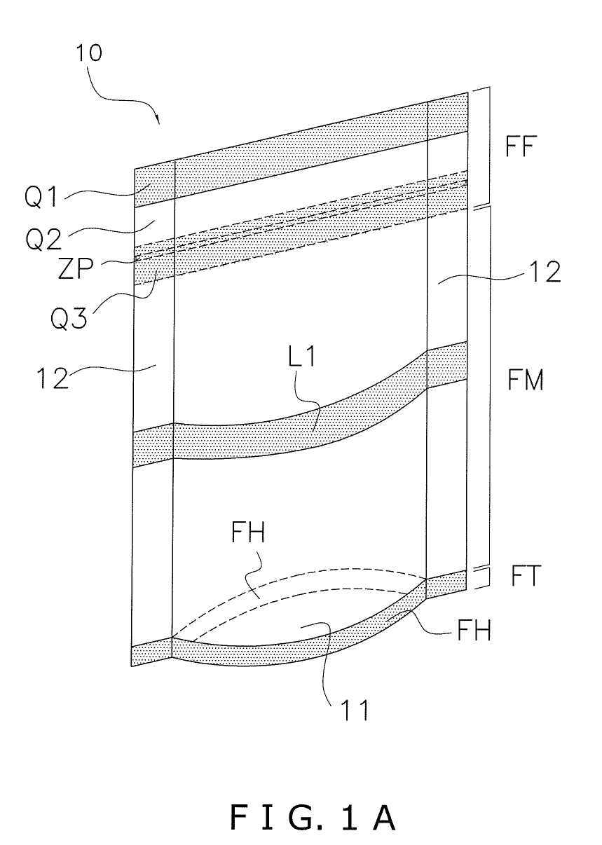

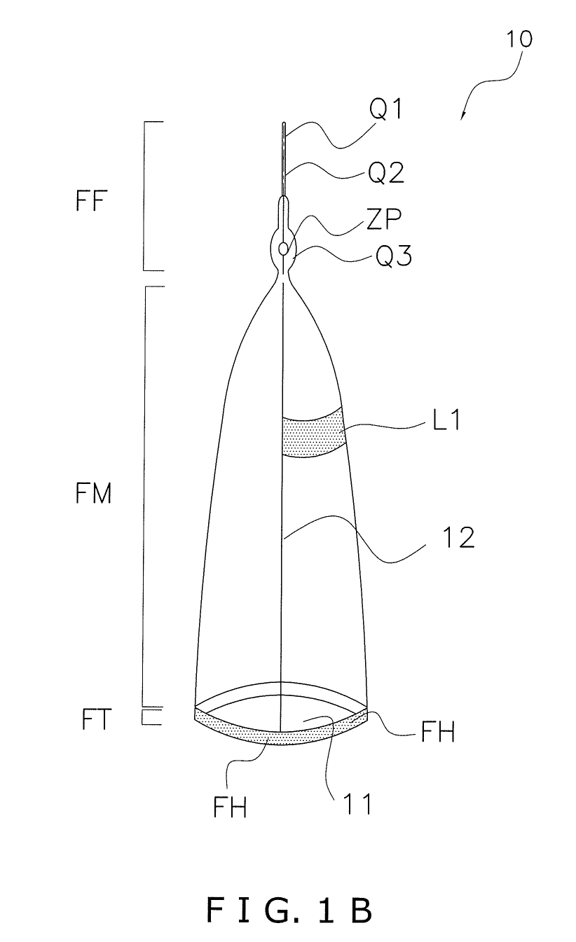

The bag-making and packaging apparatus 1 according to the present embodiment manufactures a bag 10 shown in FIGS. 1A and 1B. FIG. 1A is a perspective view of the bag 10, and FIG. 1B is a side view of the bag 10. The bag 10 has a large fold portion FF formed at the top of the bag, a bottom part FT having a bottom surface 11 and hem portions FH, FH that enclose the bottom surface 11, and a middle part FM constituting the rest of the bag 10. The bag 10 is a self-standing pouch in which the bottom part FT is the supporting part. The fold portion FF has a top sealed region Q1, a cutoff region Q2, and a zipper attachment region Q3. The top sealed region Q1 is heat-sealed. Perforations are formed in the cutoff region Q2. The top sealed region Q1 can be separated from the rest of the fold portion FF by tearing the perforations. A zipper ZP is attached to the zipper attachment region Q3. The bag 10 can thereby be resealed after being opened (after the tope sealed region Q1 is separated).

The bag-making and packaging apparatus 1 according to the present embodiment first folds the sheet-shaped film F at predetermined positions to form the fold portion FF and the hem portions FH, FH. Then, the bag-making and packaging apparatus 1 molds the film F into a cylinder or tubular shape and heat-seals (heat welds) the overlapping portion L1, and the left and right sealed regions 12, 12 of the film F, thereby forming the bag 10.

### Overall Configuration of Bag-Making and Packaging Apparatus

First, the overall configuration of the bag-making and packaging apparatus 1 will be described using FIG. 2. The bag-making and packaging apparatus 1 is a machine for packing snack foods or other products into bags. The bag-making and packaging apparatus 1 basically includes a bag-making and packaging unit 5 (bag-making and packaging mechanism) for packing products into bags, a film supply unit 2 for supplying a film F for forming the bag 10 to the bag-making and packaging unit 5, a film-conveying unit for conveying the film F supplied by the film supply unit 2 to the bag-making and packaging unit 5, and a fold formation unit 3 (fold formation mechanism) set up in the path through which the film is conveyed from the film supply unit 2 to the bag-making and packaging unit 5. On the right side of the bag-making and packaging unit 5 are disposed downward-facing operation switches 6. Furthermore, a liquid crystal display 7 for showing the operating state is disposed in a position visible to a user operating the operation switches 6. The configurations of the components of the bag-making and packaging apparatus 1 are described hereinbelow.

### Configurations of Components

### (1) Film Supply Unit

The film supply unit 2 supplies a sheet-shaped film F to a molding mechanism 50 of the bag-making and packaging unit 5, described hereinafter. The film supply unit 2 has a film roller 20. A film roll 2a around which the film F is wound is set in the film roller 20. The film roller 20 is rotated by a motor (not shown). As a result, the film F is paid out from the film roll 2a. The film F supplied to the bag-making and packaging unit from the film supply unit 2 is conveyed to the bag-making and packaging unit 5 by the action of the film-conveying unit, described hereinafter.

### (2) Film-Conveying Unit

The film-conveying unit basically includes a pair of pull-down belts 14, 14, a plurality of film-conveying rollers 15a, a film-conveying roller 15b (conveying angle changing member), and a tension roller.

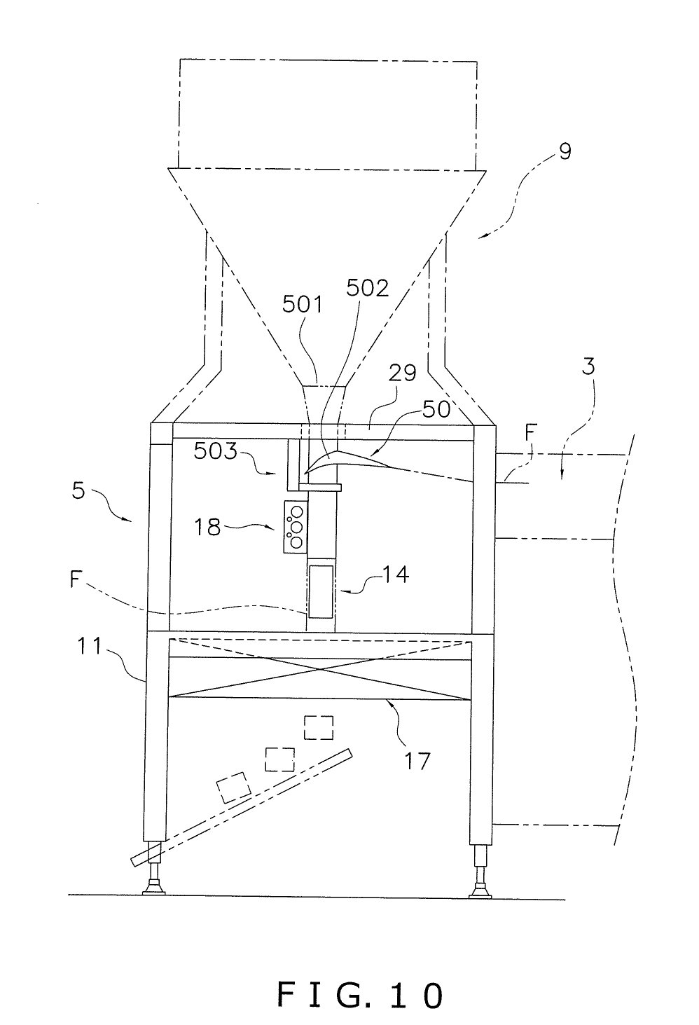

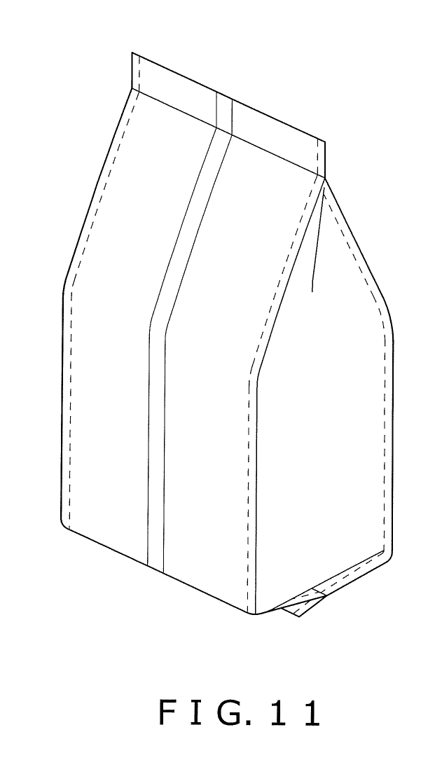

As shown in FIG. 2, the pair of pull-down belts 14, 14 is disposed in the bag-making and packaging unit 5 described hereinafter, and is supported by support members. The pull-down belts 14, 14 are disposed in bilateral symmetry about a longitudinally extending tube 501 (FIG. 10). The pull-down belts 14, 14 are configured and arranged to come into contact with the cylindrical film wound around the tube 501 and to convey the film downward while holding the film.

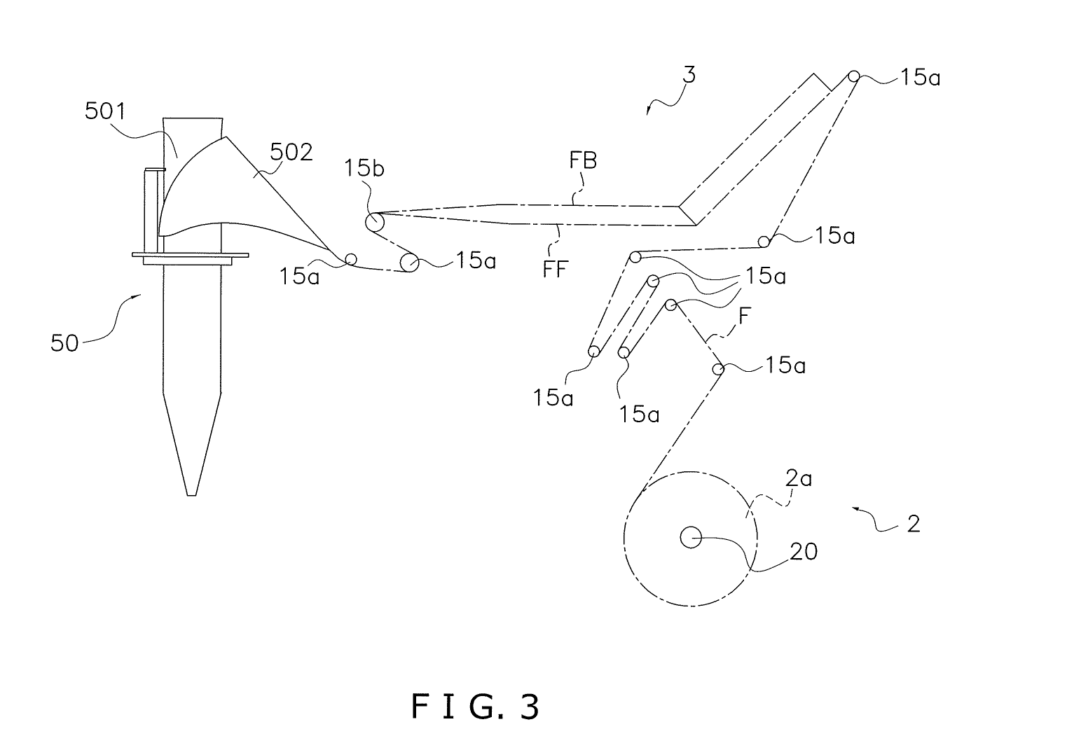

The film-conveying rollers 15a, 15b and the tension roller are provided in the conveying path of the film F. The film paid out from the film roll 2a of the film supply unit 2 is guided around the film-conveying rollers 15a, 15b and the tension roller. The film F is thereby conveyed from the film supply unit 2 to the bag-making and packaging unit 5 while under a predetermined amount of tension (see FIG. 3). As shown in FIG. 3, the conveying angle of the film F is changed every time the film passes through the film-conveying rollers 15a, 15b.

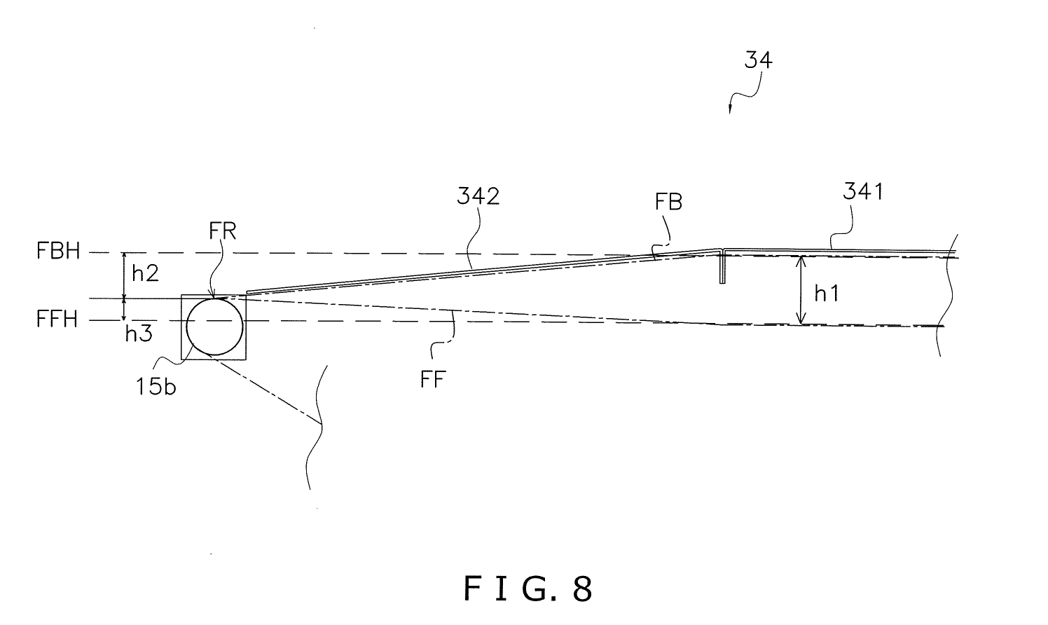

The film-conveying roller 15b is supported on a support mechanism (not shown) on the downstream side of the fold formation unit 3. The support mechanism supports the film-conveying roller 15b by support members disposed at the widthwise ends of the film F on the downstream side of the fold formation unit 3. The support mechanism is arranged so that the support position of the film-conveying roller 15b can be changed in the height direction of the fold portion FF in the film F (i.e., the vertical direction in FIG. 3). In the present embodiment, the position where the film-conveying roller 15b is supported is determined according to the height dimension h1 (FIG. 8) of the fold portion FF in the film F. A detailed description accompanies the description of a film guide part 34 given below.

### (3) Fold Formation Unit

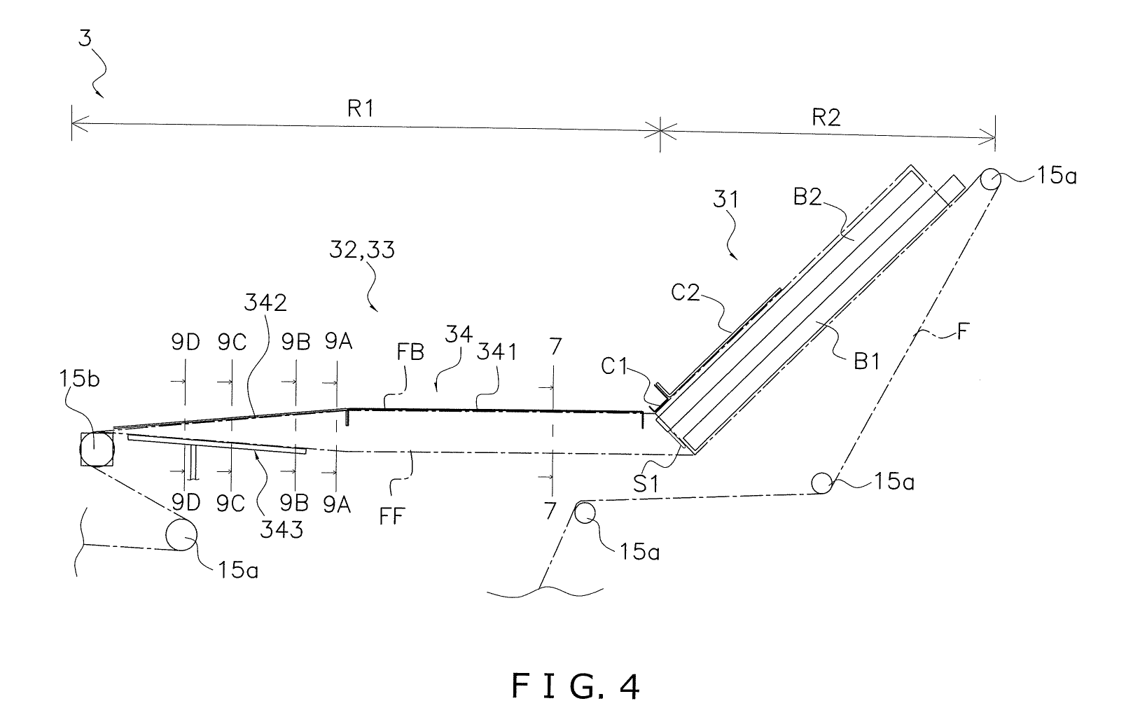

Next, the fold formation unit 3 is described using FIGS. 4 through 8.

The fold formation unit 3 is a unit for forming the fold portion FF in the sheet-shaped film F. The fold formation unit 3 also forms hem portions FH, FH in the sheet-shaped film F.

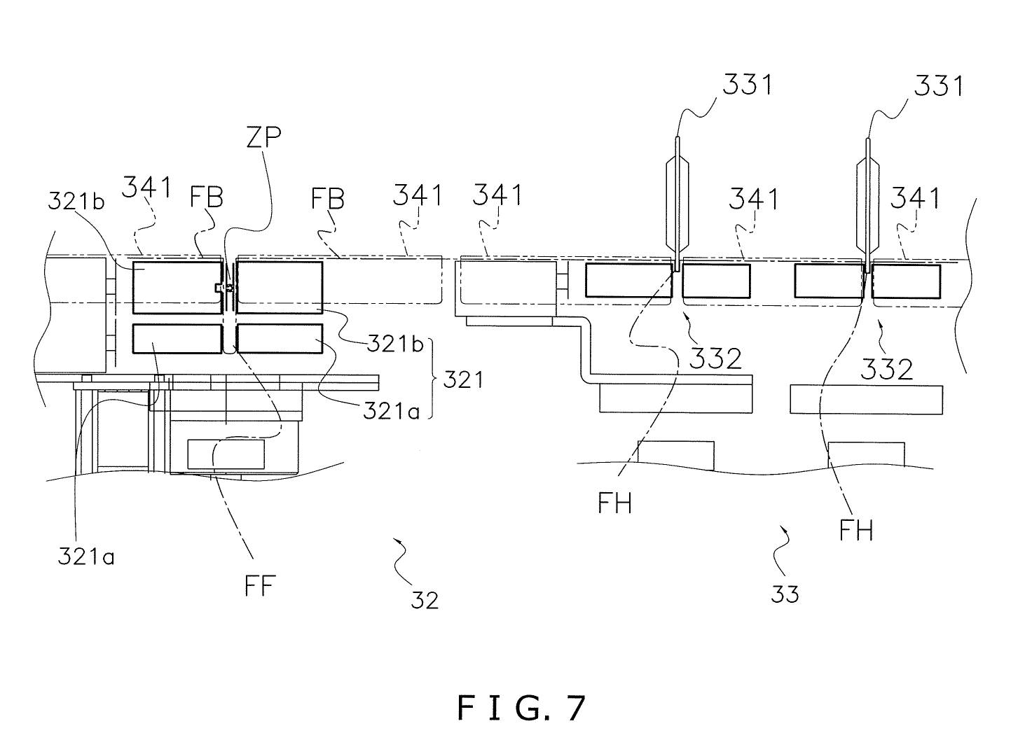

The fold formation unit 3 is divided into two main areas, i.e., areas R1, R2, as shown in FIG. 4. The area R1 (first conveying area) is an area through which a film F having a fold portion FF or a portion corresponding to a fold portion FF (hereinbelow referred to as a fold-formation portion) is conveyed. Specifically, the area R1 is an area through which a film F having a cross-sectional shape that includes a fold portion FF or a ridge portion is conveyed. The fold portion FF is a portion that is folded by three creases aligned substantially in parallel. The area R2 (second conveying area) is disposed upstream of the area R1, and the area R2 has a surface inclined to a considerable degree in relation to the conveying direction of the film F in the area R1. Specifically, in this embodiment, the area R2 is inclined at about a 45-degree angle in relation to the conveying surface of the film F conveyed substantially horizontally in the area R1. The fold formation unit 3 basically includes a conveying path regulating part 31, a fold formation part 32 (FIG. 7), a hem formation part 33 (FIG. 7), and a film guide part 34 (FIG. 8).

### a) Conveying Path Regulating Part

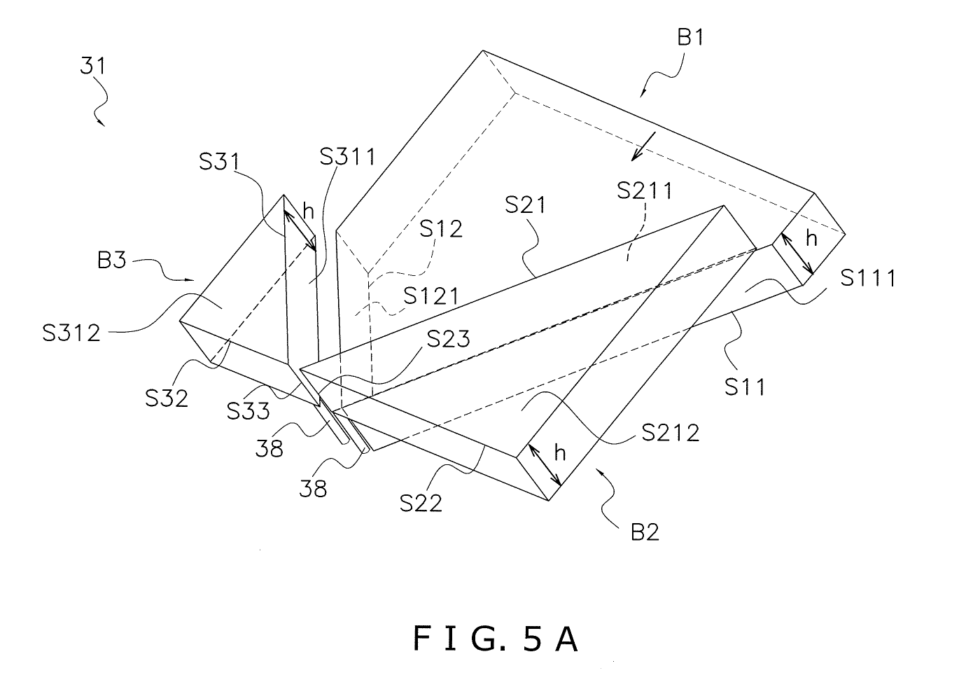

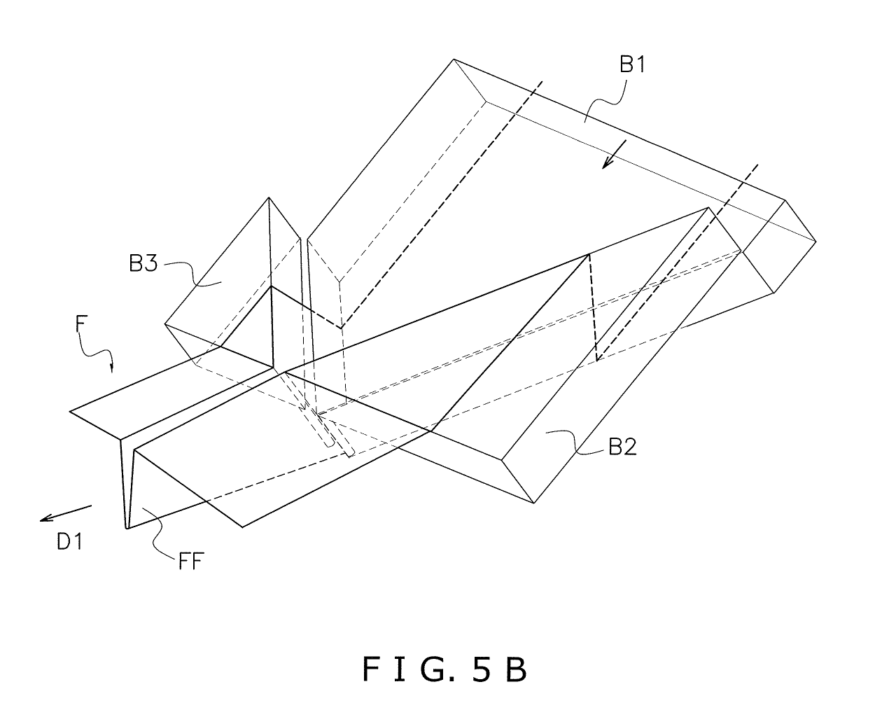

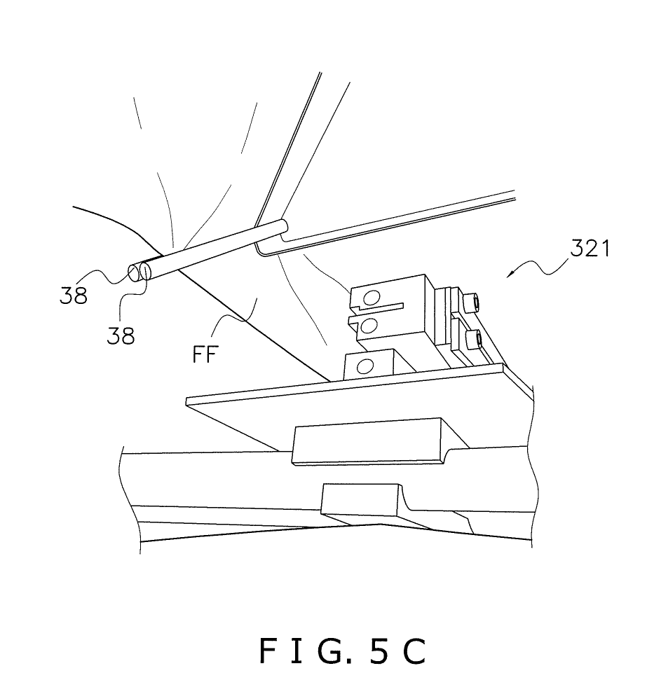

The conveying path regulating part 31 is disposed in the area R2, as shown in FIG. 4. The conveying path regulating part 31 defines the conveying path of the film F. The conveying path regulating part 31 basically includes of a plurality of blocks B1, B2, B3, as shown in FIG. 5A. The blocks B1, B2, B3 include a pentagonal prism block B1 and triangular prism blocks B2, B3. The blocks B1, B2, B3 all have sides of a predetermined height h. Specifically, the pentagonal block B1 has pentagonal bottom and top surfaces, and side surfaces of a height h extending perpendicularly from the bottom surface to the top surface. The triangular blocks B2, B3 have triangular bottom and top surfaces, and side surfaces of a height h extending perpendicularly from the bottom surfaces to the top surfaces. As described above, in this embodiment, the blocks B1, B2, B3 are set up at an incline of 45 degrees in relation to the fold formation part 32 of the area R1 as shown in FIG. 4.

The pentagonal block B1 is disposed upstream of the conveying path regulating part 31. The triangular blocks B2, B3 are both disposed downstream of the pentagonal block B1. An edge S22 of the triangular block B2 and an edge S32 of the triangular block B3 are arranged to be at the same height as an upstream guide member 341 of the film guide part 34, described hereinafter. The pentagonal block B1 and the triangular blocks B2, B3 are disposed to form small gaps between each other in the conveying direction of the film F. The small gaps are of a size that allows the film F to pass through.

Furthermore, the pentagonal block B1 and the triangular blocks B2, B3 are disposed out of alignment with each other in the height h direction. Specifically, the bottom surfaces of the triangular blocks B2, B3 are disposed so as to be positioned higher in the height h direction than an imaginary surface obtained by extending the top surface of the pentagonal block B1 (see FIGS. 5A and 5B).

The conveying path regulating part 31 is provided with a cover member C2 and a channel member C1 on the upper bases of the blocks B1, B2, B3, as shown in FIG. 5D. The blocks B1, B2, B3 and the channel member C1 form a contacting portion configured and arranged to contact with the film to change a conveying angle of the film. The channel member C1 extends in the width direction of the conveying path regulating part 31, and is disposed so as to face the edge S22 of the triangular block B2 and the edge S32 of the triangular block B3. The film F comes into contact with the channel member C1 and with the edge S22 of the triangular block B2 and the edge S32 of the triangular block B3, and the conveying angle is changed by the edge S22 of the triangular block B2 and the edge S32 of the triangular block B3. The cover member C2 is disposed upstream of the channel member C1, and the cover member C2 comes into contact with the film F conveyed over the upper bases S212, S312 of the triangular blocks B2, B3 and stabilizes the flow of the film F.

Consequently, by being passed through the gaps in the blocks B1, B2, B3 in the conveying path regulating part 31, the film F is temporarily bent and is formed into a ridge portion and other non-fold portions (i.e. the rest of the film other than the ridge portion) while the conveying angle is changed, as shown in FIG. 5B. Specifically, first, the film F is conveyed along the bottom surface of the pentagonal block B1. The film F is temporarily bent by the edges S11, S12 (first contacting section) of the pentagonal block B1, and the conveying angle is changed (first conveying angle change). The film F then passes through the gap between the side surface S111 of the pentagonal block B1 and the side surface S211 of the triangular block B2, and the gap between the side surface S121 of the pentagonal block B1 and the side surface S311 of the triangular block B3. Specifically, the film F is conveyed along the side surfaces S111 and S121 of the pentagonal block B1, the side surface S211 of the triangular block B2, and the side surface S311 of the triangular block B3. Since the film F is pulled by the pull-down belts 14, 14 in the direction of the arrow D1 (see FIG. 5B), the portion of the film F near the apex where the edges S11 and S12 of the pentagonal block B1 meet with each other passes through a gap between the edge S23 (third contacting section) of the triangular block B2 and the edge S33 (third contacting section) of the triangular block B3, and between rods 38, 38 that extend from the lower bases of the triangular blocks B2, B3 (see FIGS. 5B and 5C). A ridge portion is thereby formed in the film F. The ridge portion is a portion that is defined by three creases as shown in FIG. 5B, and that will be formed into a fold portion FF by the fold formation part 32 as described below.

Other than the ridge portion, the rest of the film F conveyed along the side surfaces S211, S311 of the triangular blocks B2, B3 comes into contact with the edge S21 (second contacting section) of the triangular block B2 and the edge S31 (second contacting section) of the triangular block B3 and is temporarily bent, and the conveying angle is further changed (second conveying direction change). The rest of the film F other than the ridge portion is then conveyed along the upper bases S212, S312 of the triangular blocks B2, B3. The rest of the film F other than the ridge portion also comes into contact with the channel member C1 (fourth contacting section) in the edges S22, S32 of the triangular blocks B2, B3, whereby the conveying angle is further changed (third conveying angle change).

### b) Fold Formation Part

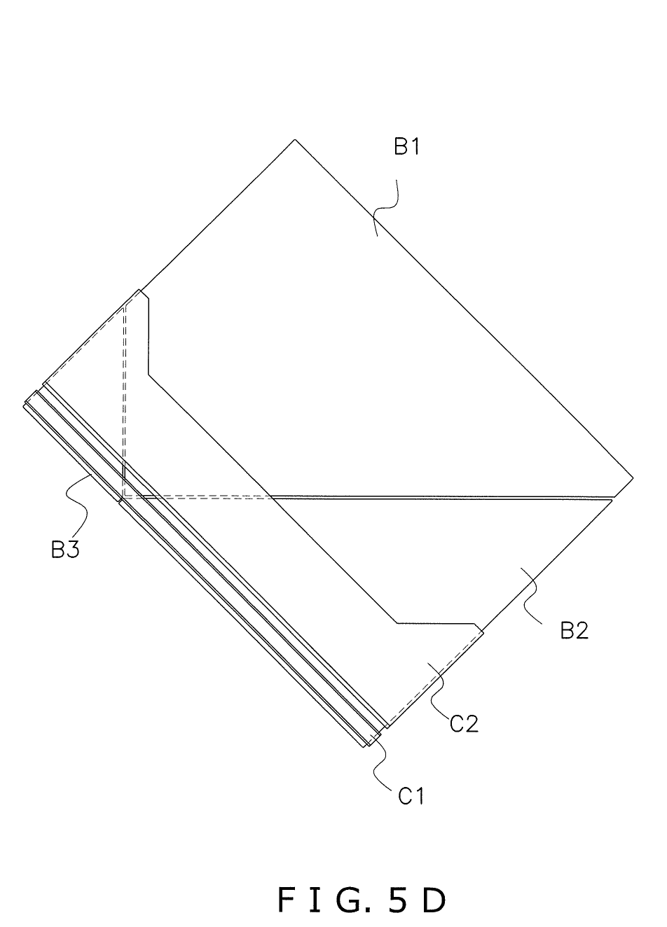

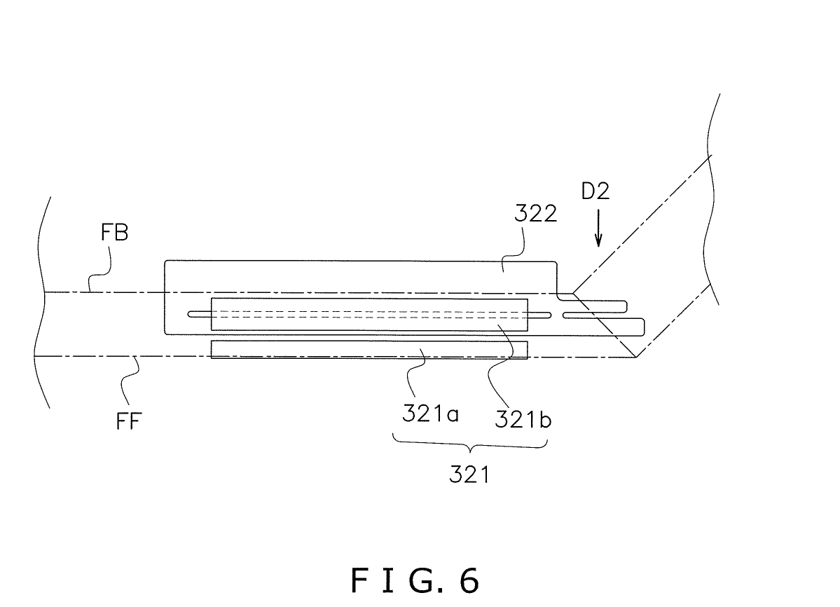

The fold formation part 32 is disposed in the area R1 shown in FIG. 4. In the fold formation part 32, the ridge portion formed in the conveying path regulating part 31 described above is formed into a fold portion FF. As shown in FIG. 6, the fold formation part 32 basically includes a heater 321, a zipper insertion member 322, and an upstream roller and downstream roller (not shown). The heater 321 applies heat to a predetermined location on the ridge portion of the film F conveyed to the fold formation part 32. The heater 321 has top end heaters 321a, 321a and base end heaters 321b, 321b. The top end heaters 321a, 321a apply heat to the portion at the top end of the ridge portion corresponding to the top sealed region Q1 of the fold portion FF. The base end heaters 321b, 321b apply heat to the portion at the base end of the ridge portion corresponding to the zipper attachment region Q3 of the fold portion FF. The zipper insertion member 322 is a member extending from upstream to downstream in the fold formation part 32, as shown in FIG. 6. The zipper insertion member 322 inserts a zipper ZP, introduced from the position shown by the arrow D2 in FIG. 6, into the overlapping portion of the film F in the ridge portion. The ridge portion of the film F fed from the conveying path regulating part 31 fits in between the upstream rollers, whereby the film is folded and fed downstream. The downstream rollers press on the two sides of the ridge portion of the film F heated by the heater 321 and bond the sides together.

### c) Hem Formation Part

The hem formation part 33 is also disposed in the area R1 shown in FIG. 4. The hem formation part 33 basically includes folding rollers 331, 331 and heaters 332, 332, as shown in FIG. 7. The folding rollers 331, 331 partially fold the film F. The heaters 332, 332 apply heat to both sides of the portions folded by the folding rollers 331, 331. The heated portions are then pressed on both sides and bonded together by rollers (not shown). The hem portions FH, FH are thereby formed in the film F.

### d) Film Guide Part

The film guide part 34 is also disposed in the area R1 shown in FIG. 4. The film guide part 34 guides the film F to the bag-making and packaging unit 5. The film guide part 34 basically includes an upstream guide member 341, a downstream guide member 342, and a slanting member 343.

The upstream guide member 341 has a plurality of flat-plate members extending from upstream to downstream in the conveying direction of the film F. The flat-plate members in the present embodiment are disposed at predetermined intervals relative to each other in the width direction of the film F so as to be generally horizontal in relation to the installation surface of the bag-making and packaging apparatus 1. As the film is being conveyed, the fold portion FF, the ridge portion and the hem portions FH, FH, or the portions corresponding to the hem portions FH, FH, pass through the gaps formed between the flat-plate members disposed at predetermined intervals relative to each other (see FIG. 7). The upstream guide member 341 comes into contact with a main portion FB, which is the portion of the film F that excludes the fold portion FF, the ridge portion and the hem portions FH, FH, or the portions corresponding to the hem portions FH, FH.

The downstream guide member 342 has a plurality of flat-plate members disposed downstream of the above-described upstream guide member 341 and extending toward the film-conveying roller 15b, as shown in FIGS. 4 and 8. Flat-plate members of the downstream guide members 342 are disposed at predetermined intervals relative to each other in the width direction of the film F in the same manner as ones of the upstream guide member 341. The fold portion FF, the ridge portion and the hem portions FH, FH, or the portions corresponding to the hem portions FH, FH pass through the gaps formed between the flat-plate members disposed at predetermined intervals relative to each other.

The downstream guide member 342 is disposed at a predetermined inclination angle in relation to the upstream guide member 341. The predetermined inclination angle is determined according to the support position of the film-conveying roller 15b. As described above, the film-conveying roller 15b is supported by a support mechanism for enabling movement in the height h1 direction of the fold portion FF in the film F, and the support position where the film-conveying roller 15b is supported in the height direction of the fold portion FF is adjusted based on the height dimension h1 of the fold portion FF formed in the film F. Specifically, the support position of the film-conveying roller 15b is adjusted so that the position FR where the film F comes into contact with the film-conveying roller 15b is located between an imaginary plane FBH and an imaginary position FFH, and so that the distance h2 from the position FR to the imaginary plane FBH is greater than the distance h3 from the position FR to the imaginary position FFH, as shown in FIG. 8. The imaginary plane FBH is a plane obtained by imaginary extending the conveyance surface of the main portion FB of the film F in the conveying direction, wherein the film is guided by the upstream guide member 341. The imaginary position FFH is a position obtained by imaginary extending the top end (free end) of the fold portion FF in the film F in the conveying direction. More specifically, the film-conveying roller 15b is supported at a position at which the distance h2 from the position FR to the imaginary plane FBH is slightly greater than half the height h1 of the fold portion FF (h2>h1÷2).

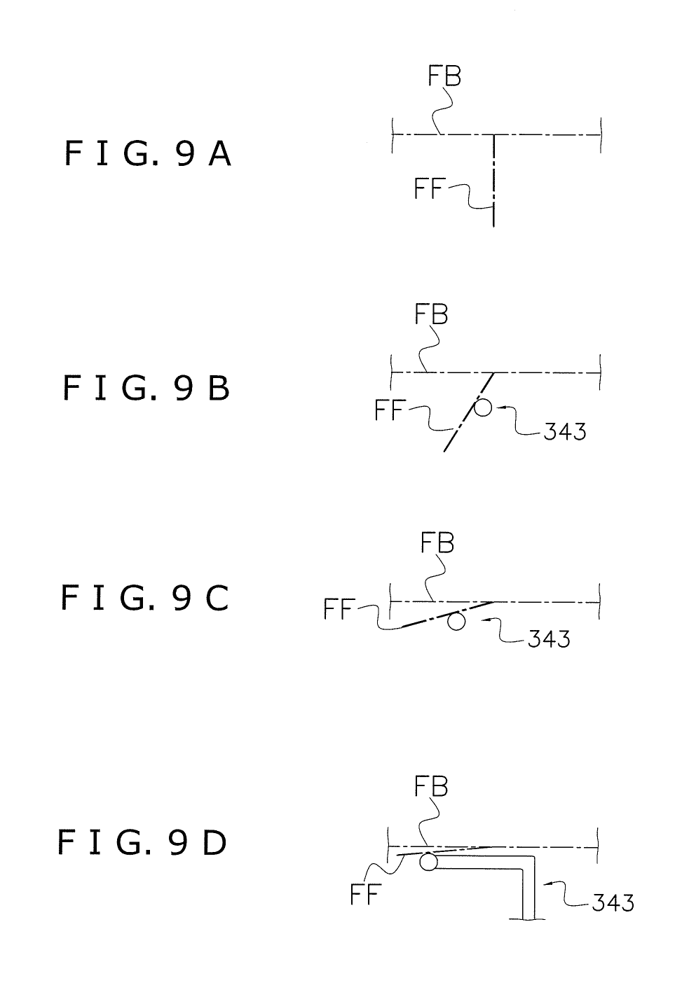

The slanting member 343 is disposed in the area where the downstream guide member 342 is provided. The slanting member 343 includes a rod part that comes into contact with the fold portion FF formed by the fold formation part 32, and causes the fold to slant at a similar incline to the main portion FB of the film F, as shown in FIGS. 9A through 9D.

### (4) Bag-Making and Packaging Unit

Next, the bag-making and packaging unit 5 will be described using FIG. 10. The bag-making and packaging unit 5 basically includes a molding mechanism 50, a vertical sealing mechanism 18, a horizontal sealing mechanism 17, and a support frame 11 for supporting these mechanisms. A casing 12 is mounted around the periphery of the support frame 11 (see FIG. 2).

### a) Molding Mechanism

The molding mechanism 50 molds the film F fed from the film supply unit 2 into a cylindrical shape. The molding mechanism 50 basically includes a tube 501 and a former 502.

The tube 501 is a cylindrical member extending in the longitudinal direction, and the tube 501 has openings in the top and bottom ends. The tube 501 is disposed so as to run vertically through an opening formed adjacent to the center of a top plate 29 of the support frame 11, and is fixed to the former 502 via a bracket (not shown). Products dropping in predetermined incremental amounts from a computer scale 9 provided above the bag-making and packaging unit 5 are guided in through the opening in the top end of the tube 501. The computer scale 9 is a combination weighing apparatus having a fold, a pool hopper, a lightweight hopper, a collection/discharge chute, and other components.

The former 502 is disposed so as to encircle the tube 501. The former 502 is shaped so that the film F fed from the film supply unit 2 is molded into a cylinder when the film F passes through the gap between the former 502 and the tube 501. The former 502 is fixed to a base plate of a molding mechanism support member 503 supported on the support frame 11.

### b) Vertical Sealing Mechanism

The vertical sealing mechanism 18 heat-seals the manufactured bag 10 along the longitudinal direction of the zipper ZP extending along the bag 10. The vertical sealing mechanism 18 is supported on a support member (not shown) suspended from the top plate 29 of the support frame 11. The vertical sealing mechanism 18 has a heater, a heater belt heated by the heater, and other components. The vertical sealing mechanism 18 heats and seals the overlapping region L1 that extends from the upstream to the downstream of the cylindrical film wrapped around the tube 501, while the region L1 is pressed against the surface of the tube 501 with a specific amount of pressure.

The vertical sealing mechanism 18 is also provided with a cutter (not shown), and perforations are formed by the cutter in the cutoff region H2 of the fold portion FF.

### c) Horizontal Sealing Mechanism

The horizontal sealing mechanism 17 heat-seals the manufactured bag 10 along a direction orthogonal to the longitudinal direction of the zipper ZP extending along the bag 10. The horizontal sealing mechanism 17 is disposed downstream of the vertical sealing mechanism 18 and is supported on the support frame 11. The horizontal sealing mechanism 17 has a pair of sealing jaws. The sealing jaws move forward and backward in synchronization with each other through a horizontal plane so as to move toward and away from each other, and press on both sides of the cylindrical film F when closest to each other. The sealing jaws have heaters inside, and the sealed regions 12, 12 of the cylindrical film pressed on both sides are heat-sealed by the heaters. With a single bilateral pressing action, the sealing jaws simultaneously form a sealed region 12 on one side of a first manufactured bag 10 (first bag) and a sealed region 12 on one side of a second manufactured bag 10 (second bag) from two bags 10, 10 manufactured consecutively by the bag-making and packaging apparatus 1. Furthermore, a cutter (not shown) is built into one of the pair of sealing jaws, and the center of the region heat-sealed by a single bilateral pressing action is cut laterally by the cutter. Bags 10 are cut by this cutting one at a time from the laterally extending cylindrical film.

### (5) Operation of Bag-Making and Packaging Apparatus

When the pull-down belts 14, 14 are driven, the film F is paid out from the film roll of the film supply unit 2. The film F is wound over the film-conveying rollers 15a, 15b and is fed to the molding mechanism 50 of the bag-making and packaging unit 5 (see FIG. 3). The film F passes through the fold formation unit 3 while being conveyed to the molding mechanism 50.

As the film F passes through the fold formation unit 3, the conveying angle of the packaging material is changed in the conveying path regulating part 31. In the conveying path regulating part 31, part of the film F passes through the gap between the edge S23 of the triangular block B2 and the rod 38 attached to the underside thereof, and the edge S33 of the triangular block B3 and the rod 38 attached to the underside thereof (see FIGS. 5B and 5C). A ridge portion is thereby formed in the film F. The film F then passes through the fold formation part 32 and the hem formation part 33. Specifically, one portion of the film F passes through the fold formation part 32, and another portion of the film F passes through the hem formation part 33, as shown in FIG. 7. A fold portion FF and hem portions FH, FH are thereby formed in the width direction of the film F. At this time, the main portion FB, which is the portion of the film F other than the fold portion FF and the hem portions FH, FH, is conveyed along the upstream guide member 341. The main portion FB of the film F is then conveyed downstream along the downstream guide member 342 toward the film-conveying roller 15b provided downstream. The fold portion FF in the film F is made to slant by the slanting member 343 at an incline that is similar to that of the main portion FB of the film F. In other words, the fold portion FF is pushed toward the adjacent portion of the film F adjacent to the fold portion FF to be generally parallel to the adjacent portion. The film F passes over the film-conveying roller 15b, whereby the conveying angle is changed, and the film F is then conveyed to the bag-making and packaging unit 5.

In the molding mechanism 50 of the bag-making and packaging unit 5, the film F having the fold portion FF and the hem portions FH, FH is conveyed along the surface of the former 502 and is wrapped around the tube 501 in a state in which the fold portion FF and the hem portions FH, FH, extend parallel to a center axis of the tube 501. The film F wrapped around the tube 501 is heat-sealed by the vertical sealing mechanism 18 at a region that will become a vertically sealed region L1. The film F is then heat-sealed by the horizontal sealing mechanism 17 at regions that will become the left and right sealed regions 12, 12 of the cylindrical film.

### FEATURES OF ILLUSTRATED EMBODIMENT

(1) The bag-making and packaging apparatus 1 according to the embodiment described above temporarily bends the film F multiple times in the fold formation unit 3 and changes the conveying angle of the film F. When the film F moves to the fold formation part 32, a predetermined portion of the film F is thereby bent to a significant degree and is formed into a fold portion FF. Since the conveying angle of the film F is varied in stages so as to define the conveying path, wrinkles formed in the bag 10 can be reduced.

(2) In the fold formation unit 3, the film F is also conveyed along the bottom surface and side surfaces S111, S121 of the pentagonal block B1, the side surface S211 and top surface S212 of the triangular block B2, and the side surface S311 and top surface S312 of the triangular block B3. The conveying angle of the film F is also changed by the contact of the film F with the edges S11, S12, S21, S31, . . . of the blocks B1, B2, B3. Since the film F is conveyed along these surfaces, the flow of the film F can be stabilized.

Furthermore, the portion in contact with the film F has a 45-degree angle in relation to the first conveying area R1. A fold portion FF can thereby be reliably formed in the film F.

(3) The positions of the pentagonal block B1 and the triangular blocks B2, B3 included in the conveying path regulating part 31 may be misaligned from each other in the height h direction of the side surfaces of the pentagonal block B1 and triangular blocks B2, B3, or the heights h of the side surfaces may be increased or reduced, whereby the size (height) of the fold portion FF formed in the fold formation part 32 can be varied.

(4) In the bag-making and packaging apparatus 1 according to the embodiment described above, the conveying path regulating part 31 is provided at an incline in relation to the fold formation part 32. Therefore, the entire length of the fold formation unit 3 can be reduced, and space can be conserved.

(5) In the bag-making and packaging apparatus 1 according to the embodiment described above, a zipper ZP is introduced from a predetermined position D2 and is inserted into the ridge portion with the use of the zipper insertion member 322. There is thereby no need to prepare a zipper ZP that matches the size of the bag, and a continuous long zipper ZP can be used.

(6) The bag-making and packaging apparatus 1 according to the embodiment described above forms a large fold portion FF in the film F in the fold formation unit 3 disposed in front of the bag-making and packaging unit 5. The large fold portion FF is formed by three creases in the predetermined position of the film F and fixed by adding heat. When the film F having the fold portion FF is conveyed to the bag-making and packaging unit 5, the bag-making and packaging apparatus 1 slants the fold portion FF at the similar incline to the main portion FB of the film F and changes the conveying angle of the film F by the film-conveying roller 15b before the bag-making and packaging unit 5.

In a case in which the film-conveying roller 15b is disposed at a position which is extended from the conveyance surface of the main portion FB of the film F guided by the upstream guide member 341, because the height h1 of the fold portion FF of the film F is high, the main portion FB of the film F will thereby be wrinkled. Consequently, the film F will be wrinkled in the conveying process to the bag-making and packaging unit 5, and as a result, there may be a trouble in the flow of the film F.

However, in the embodiment described above, the film-conveying roller 15b is supported on the support mechanism which enables the roller to move in the height direction of the fold portion FF of the film F, and the position where the film-conveying roller 15b is supported is determined according to the height dimension h1 of the fold portion FF of the film F. That is, the position of the film-conveying roller 15b is adjusted so that the position FR where the film F comes into contact with the film-conveying roller 15b is located below the middle of the height dimension h1 of the fold portion FF. The wrinkles formed in the film F can thereby be reduced during the process of conveying the film F.

(7) In the bag-making and packaging apparatus 1 according to the embodiment described above, the zipper ZP is attached at the zipper attachment region H3 of the film F. When the zipper ZP is attached to the film F, elongation of the film F in the zipper attachment region H3 differs from the elongation of the film F in other regions, and the film is likely to stretch out. The effect of this causes wrinkles to form more readily in the other portions of the film F. However, the bag-making and packaging apparatus 1 according to the embodiment described above conveys the main portion FB of the film F to the film-conveying roller 15b while conveying the film along the upstream guide member 341 and the downstream guide member 342. The wrinkles formed in the film F can thereby be reduced by the conveying process.

The bag-making and packaging apparatus 1 according to the embodiment described above conveys the film F toward the film-conveying roller 15b disposed at a predetermined position while inclining the fold portion FF. Stretching of the film F can thereby be alleviated.

### MODIFIED EXAMPLES

(A) In the conveying path regulating part 31 in the embodiment described above, the pentagonal block B1 and the triangular blocks B2, B3 were used and the conveying angle of the film F was changed by the predetermined edges S11, S12, S21, S22, S23, S31, S32, S33 of the blocks B1, B2, B3, but the conveying angle of the film F can also be changed by placing rods or the like at the positions of the predetermined edges instead of the blocks B1, B2, B3.

Furthermore, a metal die or the like for guiding the film F to the fold formation part 32 at the same conveying angle may be used instead of the plurality of blocks B1, B2, B3 used in the embodiment described above. The metal die may be formed into a curved shape, and the conveying angle of the film F may be changed multiple times before the film F enters the fold formation part 32.

The bag-making and packaging apparatus according to the illustrated embodiment can reduce wrinkles formed in bags having a fold portion when such bags are manufactured.

The bag-making and packaging apparatus according to the illustrated embodiment includes a bag-making and packaging mechanism and a fold formation mechanism. The bag-making and packaging mechanism is configured and arranged to manufacture a bag in which articles are packaged. The fold formation mechanism is configured and arranged to deform a packaging material from a planar state to a folded state having a cross-sectional shape including a fold portion formed by three creases, and to feed the packaging material to the bag-making and packaging mechanism. The fold formation mechanism has a conveying path regulating part that defines a part of a conveying path of the packaging material with the conveying path regulating part being configured and arranged to temporarily bend the packaging material for a plurality of times.

In the bag-making and packaging apparatus according to the illustrated embodiments, the planar packaging material is deformed into a shape having a large fold portion formed by three creases. The packaging material having the large fold is conveyed to the bag-making and packaging mechanism, and bags are manufactured in which articles are packaged. The conveying path of the packaging material is defined, and the portion of the packaging material outside of the fold is temporarily bent two or more times. It is thereby made possible to define the conveying path of the packaging material in stages and to reduce wrinkles formed in the bags when bags having the fold are manufactured from a planar packaging material.

Moreover, in the bag-making and packaging apparatus according to the illustrated embodiment, the fold formation mechanism includes a first conveying area in which the packaging material is conveyed in the folded state, and a second conveying area disposed upstream of the first conveying area with respect to a conveying direction of the packaging material with the conveying path regulating part being disposed in the second conveying area.

In the bag-making and packaging apparatus according to the illustrated embodiment, the fold formation mechanism has a first conveying area through which packaging material shaped with a fold is conveyed, and a second conveying area disposed in front of the first conveying area. The packaging material is temporarily bent two or more times before the fold is formed. The fold can thereby be formed in stages.

Moreover, in the bag-making and packaging apparatus according to the illustrated embodiment, the conveying path regulating part has a contacting portion configured and arranged to contact with the packaging material to change a conveying angle of the packaging material.

In the bag-making and packaging apparatus according to the illustrated embodiment, the contacting portion of the conveying path regulating part comes into contact with the packaging material, whereby the packaging material is temporarily bent and the conveying angle of the packaging material is changed. The conveying angle of the packaging material can thereby be changed while the conveying path of the packaging material is defined.

In the bag-making and packaging apparatus according to the illustrated embodiment, the contacting portion of the conveying path regulating part has a plurality of contacting sections, and at least two of the contacting sections are inclined at approximately 45 degrees with respect to the conveying direction of the packaging material in the first conveying area.

In the bag-making and packaging apparatus according to the illustrated embodiment, the contacting sections come into contact with the packaging material, and the conveying angle of the packaging material is changed. At least two of the contacting sections are inclined at 45 degrees in relation to the conveying direction of the packaging material having a fold. A fold can thereby be reliably formed.

In the bag-making and packaging apparatus according to the illustrated embodiment, the fold formation mechanism is configured and arranged to bend the packaging material twice in the second conveying area in a pair of adjacent regions of the packaging material disposed adjacent to the fold portion, and to bend the packaging material once in the adjacent regions while conveying the packaging material from the second conveying area to the first conveying area.

In the bag-making and packaging apparatus according to the illustrated embodiment, the adjacent regions of the packaging material are each bent twice in the second conveying area, and are then each bent once while being conveyed from the second conveying area to the first conveying area. The conveying angle of the packaging material can thereby be changed in stages.

In the bag-making and packaging apparatus according to the illustrated embodiment, the contacting sections include first to fourth contacting sections. The first contacting section is configured and arranged to contact with the packaging material first in the second conveying area to change the conveying angle of the packaging material. The second contacting section is configured and arranged to contact with the packaging material after the first contacting section in the second conveying area to further change the conveying angle of the packaging material. The third contacting section is configured and arranged to contact with a portion of the packaging material corresponding to the fold portion after the second contacting section while the packaging material is being conveyed from the second conveying area to the first conveying area. The fourth contacting section is configured and arranged to contact with the packaging material in the adjacent regions after the second contacting section while the packaging material is being conveyed from the second conveying area to the first conveying area.

In the bag-making and packaging apparatus according to the illustrated embodiment, the packaging material comes into contact with the first contacting section and the conveying angle is changed, and the packaging material then comes into contact with the second contacting section and the conveying angle is further changed. The portion of the packaging material equivalent to the fold then comes into contact with the third contacting section while the packaging material is being conveyed from the second conveying area to the first conveying area, and the conveying angle is changed. The portions of the packaging material equivalent to the adjacent regions come into contact with the fourth contacting section while the packaging material is being conveyed from the second conveying area to the first conveying area, and the conveying angle is changed. A portion corresponding to the fold portion (ridge portion) and portions corresponding to the adjacent regions can thereby be formed in the packaging material.

In the bag-making and packaging apparatus according to the illustrated embodiment, the first and second contacting sections are arranged with respect to each other so that a distance between the first and second contacting sections determines a height of the fold portion.

In the bag-making and packaging apparatus according to the illustrated embodiment, the height of the fold is determined according to the distance between the first contacting section and the second contacting section. The height of the fold can thereby be suitably changed.

The bag-making and packaging apparatus according to the illustrated embodiment may further include a slanting member and a conveying angle changing member. The slanting member is configured and arranged to slant the fold portion to be generally parallel to a region of the packaging material other than the folding section. The conveying angle changing member is disposed downstream of the slanting member with respect to the conveying direction of the packing material, and configured and arranged to change a conveying angle of the packing material. The conveying angle changing member is disposed in a position displaced from an imaginary plane toward a side where the fold portion is formed with the imaginary plane being obtained by extending a conveyance surface of the region other than the fold portion in the fold formation mechanism toward the conveying direction of the packing material.

In the bag-making and packaging apparatus according to the illustrated embodiment, the planar packaging material is deformed into a state of having a cross-sectional shape having a large fold, and the fold of the packing material is thereafter slanted at a similar incline to a non-fold. The packing material having the fold slanted at a similar incline to the non-fold is conveyed toward the roller disposed in a position displaced from the conveyance surface of the non-fold in the fold formation mechanism to the side where the fold of the packing material is formed. The conveying angle of the packing material is changed by the conveying angle changing member. It is thereby made possible to reduce the wrinkles formed in the bags during the conveying process.

In the bag-making and packaging apparatus according to the illustrated embodiment, the conveying angle changing member includes a roller disposed in a position displaced from the imaginary plane by a prescribed dimension that is greater than half a height of the fold portion.

In the bag-making and packaging apparatus according to the illustrated embodiment, the roller is disposed in a position displaced from an imaginary plane which is a plane obtained by extending the conveyance surface of the non-fold in the fold formation mechanism in the conveying direction of the packing material by a slightly greater range than half the height of the fold. The roller can thereby be disposed in an appropriate position in accordance with the height of the fold.

The bag-making and packaging apparatus according to the illustrated embodiment may further include a guide part extending along the conveying direction of the packing material from downstream of the fold formation mechanism to a point before the roller, and configured and arranged to guide the region of the packaging material other than the fold portion to the roller with being in contact with the packaging material.

In the bag-making and packaging apparatus according to the illustrated embodiment, the packing material formed with the fold in the fold formation mechanism is conveyed along the guide part extending from downstream of the fold formation mechanism to the point before the roller. The manufactured bags can thereby be prevented from sagging.

In the bag-making and packaging apparatus according to the illustrated embodiment, the guide part includes at least two flat-plate members disposed at a predetermined interval relative to each other, the interval being arranged to allow the fold portion pass through.

In the bag-making and packaging apparatus according to the illustrated embodiment, the two flat-plate members are disposed in the both side of the fold. The non-fold is conveyed along the two flat-plate members toward the roller. The packaging material can thereby be stably flowed.

A bag-making and packaging apparatus according to another aspect of the illustrate embodiment includes a bag-making and packaging mechanism, a fold formation mechanism, a slanting member, and a conveying angle changing member. The bag-making and packaging mechanism is configured and arranged to manufacture a bag in which articles are packaged. The fold formation mechanism is configured and arranged to deform a packaging material from a planar state to a folded state having a cross-sectional shape including a fold portion formed by three creases, and to feed the packaging material to the bag-making and packaging mechanism. The slanting member is configured and arranged to slant the fold portion to be generally parallel to a region of the packaging material other than the folding section. The conveying angle changing member is disposed downstream of the slanting member with respect to a conveying direction of the packing material, and configured and arranged to change a conveying angle of the packing material. The conveying angle changing member is disposed in a position displaced from an imaginary plane toward a side where the fold portion is formed, the imaginary plane being obtained by extending a conveyance surface of the region other than the fold portion in the fold formation mechanism toward the conveying direction of the packing material.

In the bag-making and packaging apparatus according to the illustrated embodiment, the planar packaging material is deformed into a state of having a cross-sectional shape having a large fold, and the fold of the packing material is thereafter slanted at a similar incline to a non-fold. The packing material having the fold slanted at a similar incline to the non-fold is conveyed toward the roller disposed in a position displaced from the conveyance surface of the non-fold in the fold formation mechanism to the side where the fold of the packing material is formed. The conveying angle of the packing material is changed by the conveying angle changing member. It is thereby made possible to reduce the wrinkles formed in the bags during the conveying process.

With the bag-making and packaging apparatus according to the illustrated embodiment, the conveying path of packaging material is defined in stages, and the wrinkles formed in the bags can be reduced when bags having folds are manufactured from a planar packaging material.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions with respect to the installation surface of the apparatus, and/or the conveying direction of the film. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A bag-making and packaging apparatus comprising:
a bag-making and packaging mechanism configured and arranged to manufacture a bag in which articles are packaged; and
a fold formation mechanism configured and arranged to deform a packaging material from a planar state to a folded state having a cross-sectional shape including a fold portion formed by three creases, and to feed the packaging material to the bag-making and packaging mechanism, the fold formation mechanism having a conveying path regulating part that defines a part of a conveying path of the packaging material with the conveying path regulating part being configured and arranged to temporarily bend the packaging material for a plurality of times.

2. The bag-making and packaging apparatus according to claim 1, wherein the fold formation mechanism includes
a first conveying area in which the packaging material is conveyed in the folded state, and
a second conveying area disposed upstream of the first conveying area with respect to a conveying direction of the packaging material with the conveying path regulating part being disposed in the second conveying area.

3. The bag-making and packaging apparatus according to claim 2, wherein
the conveying path regulating part has a contacting portion configured and arranged to contact with the packaging material to change a conveying angle of the packaging material.

4. The bag-making and packaging apparatus according to claim 3, wherein
the contacting portion of the conveying path regulating part has a plurality of contacting sections, and
at least two of the contacting sections are inclined at approximately 45 degrees with respect to the conveying direction of the packaging material in the first conveying area.

5. The bag-making and packaging apparatus according to claim 4, wherein
the fold formation mechanism is configured and arranged to bend the packaging material twice in the second conveying area in a pair of adjacent regions of the packaging material disposed adjacent to the fold portion, and to bend the packaging material once in the adjacent regions while conveying the packaging material from the second conveying area to the first conveying area.

6. The bag-making and packaging apparatus according to claim 5, wherein the contacting sections include
a first contacting section configured and arranged to contact with the packaging material first in the second conveying area to change the conveying angle of the packaging material,
a second contacting section configured and arranged to contact with the packaging material after the first contacting section in the second conveying area to further change the conveying angle of the packaging material,
a third contacting section configured and arranged to contact with a portion of the packaging material corresponding to the fold portion after the second contacting section while the packaging material is being conveyed from the second conveying area to the first conveying area, and
a fourth contacting section configured and arranged to contact with the packaging material in the adjacent regions after the second contacting section while the packaging material is being conveyed from the second conveying area to the first conveying area.

7. The bag-making and packaging apparatus according to claim 6, wherein
the first and second contacting sections are arranged with respect to each other so that a distance between the first and second contacting sections determines a height of the fold portion.

8. The bag-making and packaging apparatus according to claim 1, further comprising
a slanting member configured and arranged to slant the fold portion to be generally parallel to a region of the packaging material other than the folding section; and
a conveying angle changing member disposed downstream of the slanting member with respect to the conveying direction of the packing material, and configured and arranged to change a conveying angle of the packing material, the conveying angle changing member being disposed in a position displaced from an imaginary plane toward a side where the fold portion is formed, the imaginary plane being obtained by extending a conveyance surface of the region other than the fold portion in the fold formation mechanism toward the conveying direction of the packing material.

9. The bag-making and packaging apparatus according to claim 8, wherein
the conveying angle changing member includes a roller disposed in a position displaced from the imaginary plane by a prescribed dimension that is greater than half a height of the fold portion.

10. The bag-making and packaging apparatus according to claim 9, further comprising
a guide part extending along the conveying direction of the packing material from downstream of the fold formation mechanism to a point before the roller, and configured and arranged to guide the region of the packaging material other than the fold portion to the roller with being in contact with the packaging material.

11. The bag-making and packaging apparatus according to claim 10, wherein
the guide part includes at least two flat-plate members disposed at a predetermined interval relative to each other, the interval being arranged to allow the fold portion pass through.

12. A bag-making and packaging apparatus comprising:
a bag-making and packaging mechanism configured and arranged to manufacture a bag in which articles are packaged;
a fold formation mechanism configured and arranged to deform a packaging material from a planar state to a folded state having a cross-sectional shape including a fold portion formed by three creases, and to feed the packaging material to the bag-making and packaging mechanism;
a slanting member configured and arranged to slant the fold portion to be generally parallel to a region of the packaging material other than the folding section; and
a conveying angle changing member disposed downstream of the slanting member with respect to a conveying direction of the packing material, and configured and arranged to change a conveying angle of the packing material, the conveying angle changing member being disposed in a position displaced from an imaginary plane toward a side where the fold portion is formed, the imaginary plane being obtained by extending a conveyance surface of the region other than the fold portion in the fold formation mechanism toward the conveying direction of the packing material.

13. The bag-making and packaging apparatus according to claim 12, wherein
the conveying angle changing member includes a roller disposed in a position displaced from the imaginary plane by a prescribed dimension that is greater than half a height of the fold portion.

14. The bag-making and packaging apparatus according to claim 13, further comprising
a guide part extending along the conveying direction of the packing material from downstream of the fold formation mechanism to a point before the roller, and configured and arranged to guide the region of the packaging material other than the fold portion to the roller with being in contact with the packaging material.

15. The bag-making and packaging apparatus according to claim 14, wherein
the guide part includes at least two flat-plate members disposed at a predetermined interval relative to each other, the interval being arranged to allow the fold portion pass through.
